(19) United States
(12) Patent Application Publication
(10) Pub. No.: US 2022/0066270 A1
(43) Pub. Date: Mar. 3, 2022

(54) PIXEL STRUCTURE AND DISPLAY PANEL

(71) Applicant: SHENZHEN CHINA STAR OPTOELECTRONICS SEMICONDUCTOR DISPLAY TECHNOLOGY CO., LTD, Shenzhen, Guangdong (CN)

(72) Inventor: Xianjin GE, Shenzhen (CN)

(73) Assignee: SHENZHEN CHINA STAR OPTOELECTRONICS SEMICONDUCTOR DISPLAY TECHNOLOGY CO., LTD., Shenzhen, Guangdong (CN)

(21) Appl. No.: 15/734,732

(22) PCT Filed: Oct. 23, 2020
(86) PCT No.: PCT/CN2020/123183

§ 371 Date: Dec. 3, 2020

(30) Foreign Application Priority Data
Sep. 3, 2020 (CN) 202010913214.3

(51) Int. Cl. G02F 1/1343; G02F 1/1337

(52) U.S. Cl. CPC G02F 1/134345; G02F 1/133707; G02F 1/13439

(57) ABSTRACT

A pixel structure and a display panel are disclosed. The pixel structure includes a first subpixel and a second subpixel having different colors from each other. The first subpixel is a blue subpixel and includes a first stem electrode. The second subpixel includes a second stem electrode. The first stem electrode has a width greater than a width of the second stem electrode.

### BACKGROUND OF INVENTION

### 1. Field of Invention

The present invention relates to a technical field of displays, and particularly to, a pixel structure and a display panel.

### 2. Related Art

In current liquid crystal display (LCD) panels, each pixel generally includes a red subpixel, a green subpixel, and a blue subpixel. For general display images of LCD panels such as skin tone color, blue subpixels take up a higher grayscale proportion in pixels when being viewed from side views than a grayscale proportion of the blue subpixels in the pixels when being viewed from front views. As a result, grayscale ratios of red subpixels, green subpixels, and blue subpixels in side views are varied in comparison with grayscale ratios in front views, thereby causing changes in hues, saturation, and brightness of images of the LCD panels from side views, resulting in skin tone color casts.

A technical problem is that in current liquid crystal panels, for general display images of LCD panels such as skin tone color, blue subpixels take up a higher grayscale proportion in pixels when viewing the LCD panels from side views than a grayscale proportion of the blue subpixels in the pixels when viewing the LCD panels from front views, thereby causing changes in hues, saturation, and brightness of images of the LCD panels from side views, resulting in skin tone color casts.

### SUMMARY OF INVENTION

In a first aspect, an object of the present invention is to provide a pixel structure, comprising a first subpixel comprising a first stem electrode; a second subpixel having a color different from that of the first subpixel and comprising a second stem electrode; wherein the first subpixel is a blue subpixel, and the first stem electrode has a width greater than a width of the second stem electrode.

In one embodiment, a plurality of first domains are defined in the first subpixel by the first stem electrode, each of the first domains is provided with a first slit electrode group connected to the first stem electrode, and each of the first slit electrode groups comprises a plurality of branch electrodes arranged obliquely and spaced apart from each other; wherein a plurality of second domains are defined in the second subpixel by the second stem electrode, each of the second domains is provided with a second slit electrode group connected to the second stem electrode, and each of the second slit electrode groups comprises a plurality of limb electrodes arranged obliquely and spaced apart from each other.

In one embodiment, a sum of widths of all the branch electrodes in each of the first domains is less than a sum of widths of all the limb electrodes in each of the second domains.

In one embodiment, in each of the first domains, the greater a distance from the branch electrode to a central region of the first domain is, the smaller a width of the branch electrode is, and in each of the second domains, the greater a distance from the limb electrode to a central region of the second domain is, the smaller a width of the limb electrode is.

In one embodiment, in each of the first domains, the greater a distance from the branch electrode to a central region of the first domain is, the greater a width of the branch electrode is, and in each of the second domains, the greater a distance from the limb electrode to a central region of the second domain is, the greater a width of the limb electrode is.

In one embodiment, in each of the first domains, the first slit electrode group comprises a first branch electrode located closest to the central region of the first domain, and a second branch electrode and a third branch electrode sequentially arranged in a direction away from the first branch electrode; and in each of the second domains, the second slit electrode group comprises a first limb electrode located closest to the central region of the second domain, and a second limb electrode and a third limb electrode sequentially arranged in a direction away from the first limb electrode; wherein the first branch electrode has a width less than that of the first limb electrode, the second branch electrode has a width less than that of the second limb electrode, and the third branch electrode has a width less than that of the third limb electrode.

In one embodiment, the first branch electrode and the second branch electrode are spaced at a spacing greater than a spacing between the first limb electrode and the second limb electrode, and the second branch electrode and the third branch electrode are spaced at a spacing greater than a spacing between the second limb electrode and the third limb electrode.

In one embodiment, each of the branch electrodes has a width less than a width of any one of the limb electrodes.

In one embodiment, the first stem electrode comprises a first stem body arranged transversely and a second stem body arranged longitudinally, and the second stem electrode comprises a third stem body arranged transversely and a fourth stem body arranged longitudinally.

In a second aspect, the present application further provides a display panel, comprising a substrate and a pixel structure disposed on the substrate, and the pixel substrate comprising a first subpixel comprising a first stem electrode; a second subpixel having a color different from that of the first subpixel and comprising a second stem electrode; wherein the first subpixel is a blue subpixel, and the first stem electrode has a width greater than a width of the second stem electrode.

In one embodiment, a plurality of first domains are defined in the first subpixel by the first stem electrode, each of the first domains is provided with a first slit electrode group connected to the first stem electrode, and each of the first slit electrode groups comprises a plurality of branch electrodes arranged obliquely and spaced apart from each other; wherein a plurality of second domains are defined in the second subpixel by the second stem electrode, each of the second domains is provided with a second slit electrode group connected to the second stem electrode, and each of the second slit electrode groups comprises a plurality of limb electrodes arranged obliquely and spaced apart from each other.

In one embodiment, all the branch electrodes in each of the first domains are arranged in parallel with each other, and all the limb electrodes in each of the second domains are arranged in parallel with each other.

In one embodiment, a sum of widths of all the branch electrodes in each of the first domains is less than a sum of widths of all the limb electrodes in each of the second domains.

In one embodiment, in each of the first domains, the greater a distance from the branch electrode to a central region of the first domain is, the smaller a width of the branch electrode is, and in each of the second domains, the greater a distance from the limb electrode to a central region of the second domain is, the smaller a width of the limb electrode is.

In one embodiment, in each of the first domains, the greater a distance from the branch electrode to a central region of the first domain is, the greater a width of the branch electrode is, and in each of the second domains, the greater a distance from the limb electrode to a central region of the second domain is, the greater a width of the limb electrode is.

In one embodiment, in each of the first domains, the first slit electrode group comprises a first branch electrode located closest to the central region of the first domain, and a second branch electrode and a third branch electrode sequentially arranged in a direction away from the first branch electrode; and in each of the second domains, the second slit electrode group comprises a first limb electrode located closest to the central region of the second domain, and a second limb electrode and a third limb electrode sequentially arranged in a direction away from the first limb electrode; wherein the first branch electrode has a width less than that of the first limb electrode, the second branch electrode has a width less than that of the second limb electrode, and the third branch electrode has a width less than that of the third limb electrode.

In one embodiment, the first branch electrode and the second branch electrode are spaced at a spacing greater than a spacing between the first limb electrode and the second limb electrode, and the second branch electrode and the third branch electrode are spaced at a spacing greater than a spacing between the second limb electrode and the third limb electrode.

In one embodiment, each of the branch electrodes has a width less than a width of any one of the limb electrodes.

In one embodiment, the first stem electrode comprises a first stem body arranged transversely and a second stem body arranged longitudinally, and the second stem electrode comprises a third stem body arranged transversely and a fourth stem body arranged longitudinally, wherein the first stem body has a width greater than that of the third stem body, and/or the second stem body has a width greater than that of the fourth stem body.

In one embodiment, the pixel structure further comprises a third subpixel, the second subpixel is one of a red subpixel or a green subpixel, and the third subpixel is the other one of the red subpixel or the green subpixel.

By setting a size of a pixel electrode of a blue subpixel and sizes of pixel electrodes of subpixels of other colors, a width of each of stem electrodes of a red subpixel and a green subpixel is less than a width of a stem electrode of the blue subpixel. Furthermore, by setting a width of each of slit electrodes of the red subpixel and the green subpixel to be greater than a width of a slit electrode of the blue subpixel, an active display area of the blue subpixel is reduced, thereby reducing a grayscale proportion of the blue subpixel at side viewing angles, and effectively remedying a color cast problem of skin tone colors at large viewing angles. In addition, widths of the slit electrodes of the red subpixel, the green subpixel, and the blue subpixel are configured to be gradually varied to further improve display effects of the display panel from side views.

### BRIEF DESCRIPTION OF DRAWINGS

The following describes the specific implementations of the present application in detail with reference to the accompanying drawings, which will make the technical solutions and other beneficial effects of the present application obvious.

FIG. 1 is a first type schematic structural view of a pixel structure of the present application.

FIG. 2 is a second type schematic structural view of a pixel structure of the present application.

FIG. 3 is a third type schematic structural view of a pixel structure of the present application.

FIG. 4 is a fourth type schematic structural view of a pixel structure of the present application.

### DESCRIPTION OF PREFERRED EMBODIMENTS

The following embodiments are referring to the accompanying drawings for exemplifying specific implementable embodiments of the present invention. Directional terms described by the present invention, such as upper, lower, front, back, left, right, inner, outer, side, etc., are only directions by referring to the accompanying drawings, and thus the used directional terms are used to describe and understand the present invention, but the present invention is not limited thereto. In the figure drawings, the units with similar structure are represented by the same reference numerals.

The present application is provided to overcome a technical problem that in current liquid crystal panels, for general display images of liquid crystal panels such as skin tone color, blue subpixels take up a higher grayscale proportion in pixels when viewing the liquid crystal panels from side views than a grayscale proportion of the blue subpixels in the pixels when viewing the liquid crystal panels from front views, thereby causing changes in hues, saturation, and brightness of images of the liquid crystal panels from side views and resulting in skin tone color casts.

An embodiment of the present application provides a pixel structure, including a plurality of pixels. Each of the pixels include a plurality of subpixels having pixel electrodes.

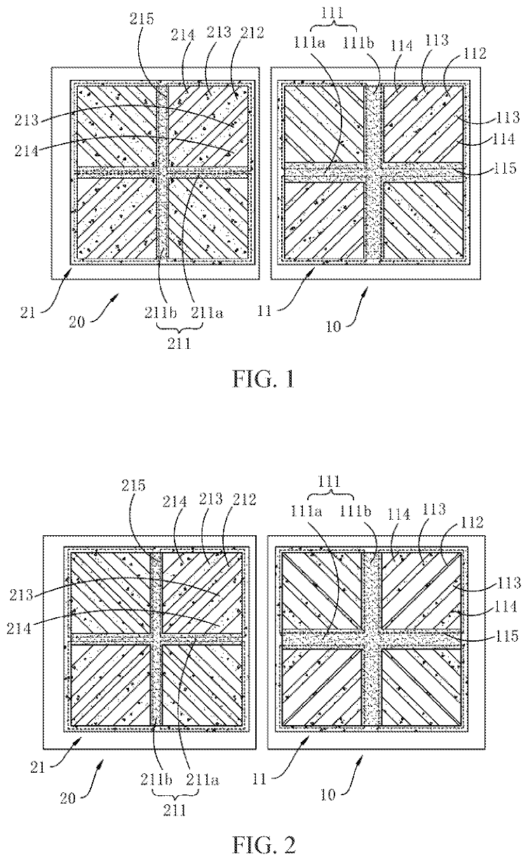

Specifically, as shown in FIGS. 1 and 2, each of the pixels includes at least a first subpixel 10 and a second subpixel 20. The first subpixel 10 has a color different from that of the second subpixel 20, and the first subpixel 10 may have the same area as that of the second subpixel 20.

The first subpixel 10 is a blue subpixel, and the second subpixel 20 may by a red subpixel or a green subpixel.

Specifically, the first subpixel 10 has a first pixel electrode 11 including a first stem electrode 111, the second subpixel 20 has a second pixel electrode 21 including a second stem electrode 211, and the first stem electrode 111 has a width greater than a width of the second stem electrode 211.

It should be noted that by setting the width of the first stem electrode 111 of the first subpixel 10 and the width of the second stem electrode 211 of the second subpixel 20, an active display area of blue subpixels can be reduced, thereby reducing a grayscale proportion taken up by the blue subpixels in the pixels when viewing the pixels from side views, and effectively remedying a color cast problem of skin tone colors at large viewing angles.

Specifically, the first stem electrode 111 is configured to define the first subpixel 10 into a plurality of first domains 115. Each of the first domains 115 is provided with a first slit electrode group connected to the first stem electrode 111, and each of the first slit electrode groups includes a plurality of branch electrodes arranged obliquely and spaced apart from each other. That is, each of the branch electrodes and the first stem electrode 111 form an angle, which is obtuse or acute.

Further, the second stem electrode 211 is configured to define the second subpixel 20 into a plurality of second domains 215. Each of the second domains 215 is provided with a second slit electrode group connected to the second stem electrode 211, and each of the second slit electrode groups includes a plurality of limb electrodes arranged obliquely and spaced apart from each other. That is, each of the limb electrodes and the second stem electrode 111 form an angle, which is obtuse or acute.

It should be noted that the first slit electrode group and the second slit electrode group each include a plurality of slit electrodes. The slit electrodes in the first slit electrode group are the branch electrodes, and the slit electrodes in the second slit electrode group are the limb electrodes.

Specifically, the first domains 115 are independent of each other, and the branch electrodes in adjacent two of the first domains 115 are inclined at different angles. The second domains 215 are independent of each other, and the limb electrodes in adjacent two of the second domains 215 are inclined at different angles.

In one embodiment, the first stem electrode 111 and the second stem electrode 211 may both be cross-shaped, a number of the first domains 115 may be four, and a number of the second domains 215 may also be four.

In one embodiment, the first stem electrode 111 includes a first stem body 111a arranged transversely and a second stem body 111b arranged longitudinally. The second stem electrode 211 includes a third stem body 211a arranged transversely and a fourth stem body 211b arranged longitudinally.

Specifically, the first stem body 111a has a width greater than a width of third stem body 211a, and/or the second stem body 111b has a width greater than a width of the fourth stem body 211b.

In one embodiment, all the branch electrodes in each of the first domains 115 are arranged in parallel with each other. The branch electrodes in two of the first domains 115 distributed diagonally are symmetric about an intersection of the first stem electrode 111. The branch electrodes arranged transversely in adjacent two of the first domains 115 are symmetric about the second stem body 111b. The branch electrodes arranged longitudinally in adjacent two of the first domains 115 are symmetric about the first stem body 111a.

In one embodiment, all the limb electrodes in each of the second domains 215 are arranged in parallel with each other. The limb electrodes in two of the second domains 215 distributed diagonally are symmetric about an intersection of the second stem electrode 211. The limb electrodes arranged transversely in adjacent two of the second domains 215 are symmetric about the fourth stem body 211b. The limb electrodes arranged longitudinally in adjacent two of the second domains 215 are symmetric about the third stem body 211a.

In one embodiment, a sum of widths of all the branch electrodes in each of the first domains 115 is less than a sum of widths of all the limb electrodes in each of the second domains 215.

It should be noted that an active display area of the second subpixel 20 is increased by increasing the widths of the limb electrodes, or an active display area of the first subpixel 10 is reduced by reducing the widths of the branch electrodes, thereby reducing a grayscale proportion taken up by the blue subpixels at side viewing angles, and effectively remedying a color cast problem of skin tone colors at large viewing angles.

Specifically, as shown in FIG. 1, in each of the first domains 115, the greater a distance from the branch electrode to a central region of the first domain 115 is, the smaller a width of the branch electrode is, and in each of the second domains 215, the greater a distance from the limb electrode to a central region of the second domain 215 is, the smaller a width of the limb electrode is.

As shown in FIG. 2, alternatively, in each of the first domains 115, the greater a distance from the branch electrode to a central region of the first domain 1115 is, the greater a width of the branch electrode is, and in each of the second domains 215, the greater a distance from the limb electrode to a central region of the second domain 215 is, the greater a width of the limb electrode is.

It should be noted that the width of each of the branch electrodes in each of the first domains 115 in the first subpixel 10 gradually increases or reduces from the central region to outer sides of the first domain 115, and the width of each of the limb electrodes in each of the second domains 215 gradually increases or reduces from the central region to outer sides of the second domain 215, thereby making the arrangement of the branch electrodes and the limb electrodes exhibit a stronger sense of gradation, and further improving display effects of the display panel from side views.

Specifically, in each of the first domains 115, the first slit electrode group includes a first branch electrode 112 located closest to the central region of the first domain 115. In each of the second domains 215, the second slit electrode group includes a first limb electrode 212 located closest to the central region of the second domain 215.

In one embodiment, the branch electrodes located on two sides of the first branch electrode 112 are symmetric about the first branch electrode 112. The limb electrodes located on two sides of the first limb electrode 212 are symmetric about the first limb electrode 212.

It should be noted that the widths of the branch electrodes in each of the first domains 115 may be different from each other, and the widths of the limb electrodes in each of the second domains 215 may be different from each other.

Specifically, the first slit electrode group further includes a second branch electrode 113 and a third branch electrode 114 sequentially arranged in a direction away from the first branch electrode 112. The second slit electrode group includes a second limb electrode 213 and a third limb electrode 214 sequentially arranged in a direction away from the first limb electrode 212.

The first branch electrode 112 has a width less than that of the first limb electrode 212, the second branch electrode 113 has a width less than that of the second limb electrode 213, and the third branch electrode 114 has a width less than that of the third limb electrode 214.

It should be noted that the first branch electrode 112 and the first limb electrode 212 correspond to each other, the second branch electrode 113 and the second limb electrode 213 correspond to each other, the third branch electrode 114 and the third limb electrode 214 correspond to each other, and each of the branch electrodes in the first domain 115 has a width less than a width of a corresponding one of the limb electrodes in the second domain 215, thereby ensuring that a sum of the widths of all the branch electrodes in the first domains is less than a sum of the widths of all the limb electrodes in the second domain 215, so that as display effects of the display panel at side viewing angles are improved, an active display area of the blue subpixels is reduced, thereby reducing a grayscale proportion of the blue subpixels at the side viewing angles.

It should be noted that the branch electrodes in the first domain 115 may be corresponding to the limb electrodes in the second domain 215, respectively. A fourth branch electrode, a fifth branch electrode, and more branch electrodes may further be sequentially disposed on a side of the third branch electrode 114 away from the first branch electrode 112 in a direction away from the first branch electrode 112. In this manner, a fourth limb electrode, a fifth limb electrode, and more limb electrodes may further be sequentially disposed on a side of the third limb electrode 214 away from the first limb electrode 212 in a direction away from the first limb electrode 212, wherein the fourth branch electrode has a width less than a width of the fourth limb electrode, and the fifth branch electrode has a width less than a width of the fifth limb electrode, and so on.

In one embodiment, the width of each of the branch electrodes is less than that of any one of the limb electrodes. That is, a greatest width of one of the branch electrodes is less than a smallest width of one of the limb electrodes in the second domain 215.

Specifically, any adjacent two of the branch electrodes are spaced at a same or different spacing. That is, a width of a first slit formed between any adjacent two of the branch electrodes may be the same or different. Any adjacent two of the limb electrodes are spaced at a same or different spacing. That is, a width of a second slit formed between any adjacent two of the limb electrodes may be the same or different.

When any adjacent two of the branch electrodes are spaced at a different spacing, the closer a distance from the first slit to a central region of the first domain 115 is, the greater/smaller a width of the first slit is. When any adjacent two of the branch electrodes are spaced at a different spacing, the closer a distance from the second slit to a central region of the second domain 215 is, the greater/smaller a width of the second slit is.

Specifically, the first branch electrode 112 and the second branch electrode 113 are spaced at a spacing greater than a spacing between the first limb electrode 212 and the second limb electrode 213. The second branch electrode 113 and the third branch electrode 114 are spaced at a spacing greater than a spacing between the second limb electrode 213 and the third limb electrode 214.

It should be noted that when the fourth branch electrode, the fifth branch electrode, and more branch electrodes are sequentially disposed on the side of the third branch electrode 114 away from the first branch electrode 112 in the direction away from the first branch electrode 112, and the fourth limb electrode, the fifth limb electrode, and more limb electrodes are sequentially disposed on the side of the third limb electrode 214 away from the first limb electrode 212 in the direction away from the first limb electrode 212, a spacing between the third branch electrode 114 and the fourth branch electrode is greater than a spacing between the third limb electrode 214 and the fourth limb electrode, a spacing between the fourth branch electrode and the fifth branch electrode is greater than a spacing between the fourth limb electrode and the fifth limb electrode, and so on.

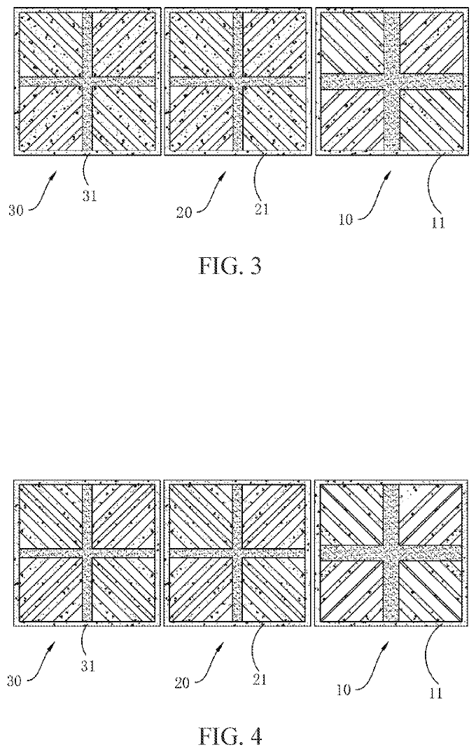

As shown in FIGS. 3 and 4, each of the pixels may further includes a third subpixel 30, the second subpixel 20 is one of a red subpixel or a green subpixel, and the third subpixel 30 is the other one of the red subpixel or the green subpixel.

Specifically, the third subpixel 30 may have a same shape as that of the second subpixel 20. The third subpixel 30 includes a third pixel electrode 31 having a same shape as that of the second pixel electrode 21 of the second subpixel 20, and the third pixel electrode 31 of the third subpixel 30 may have a same size as that of the second pixel electrode 21 of the second subpixel 20.

Based on the above-mentioned pixel structure, the present application further provides a display panel. The display panel includes a substrate and the pixel structure described in any of the above embodiments. The pixel structure is disposed on the substrate, and the display panel may be a liquid crystal display panel.

In the above-mentioned embodiments, the description of each embodiment has its own focus. For parts that are not described in detail in an embodiment, reference may be made to related descriptions of other embodiments.

Specific examples are used in this article to describe the principles and implementation of the application. The description of the above examples is only used to help understand the technical solutions and core ideas of the application. Those of ordinary skill in the art should understand that they can still modify the technical solutions stated in the foregoing embodiments, or equivalently replace some of the technical features; and these modifications or replacements do not cause the essence of the corresponding technical solutions to deviate from the scope of the technical solutions of the embodiments of the present application.

What is claimed is:

1. A pixel structure, comprising:
a first subpixel comprising a first stem electrode;
a second subpixel having a color different from that of the first subpixel and comprising a second stem electrode;
wherein the first subpixel is a blue subpixel, and the first stem electrode has a width greater than a width of the second stem electrode.

2. The pixel structure of claim 1, wherein a plurality of first domains are defined in the first subpixel by the first stem electrode, each of the first domains is provided with a first slit electrode group connected to the first stem electrode, and each of the first slit electrode groups comprises a plurality of branch electrodes arranged obliquely and spaced apart from each other;
wherein a plurality of second domains are defined in the second subpixel by the second stem electrode, each of the second domains is provided with a second slit electrode group connected to the second stem electrode, and each of the second slit electrode groups comprises a plurality of limb electrodes arranged obliquely and spaced apart from each other.

3. The pixel structure of claim 2, wherein a sum of widths of all the branch electrodes in each of the first domains is less than a sum of widths of all the limb electrodes in each of the second domains.

4. The pixel structure of claim 3, wherein in each of the first domains, the greater a distance from the branch electrode to a central region of the first domain is, the smaller a width of the branch electrode is, and in each of the second domains, the greater a distance from the limb electrode to a central region of the second domain is, the smaller a width of the limb electrode is.

5. The pixel structure of claim 3, wherein in each of the first domains, the greater a distance from the branch electrode to a central region of the first domain is, the greater a width of the branch electrode is, and in each of the second domains, the greater a distance from the limb electrode to a central region of the second domain is, the greater a width of the limb electrode is.

6. The pixel structure of claim 5, wherein in each of the first domains, the first slit electrode group comprises a first branch electrode located closest to the central region of the first domain, and a second branch electrode and a third branch electrode sequentially arranged in a direction away from the first branch electrode; and
in each of the second domains, the second slit electrode group comprises a first limb electrode located closest to the central region of the second domain, and a second limb electrode and a third limb electrode sequentially arranged in a direction away from the first limb electrode;
wherein the first branch electrode has a width less than that of the first limb electrode, the second branch electrode has a width less than that of the second limb electrode, and the third branch electrode has a width less than that of the third limb electrode.

7. The pixel structure of claim 6, wherein the first branch electrode and the second branch electrode are spaced at a spacing greater than a spacing between the first limb electrode and the second limb electrode, and the second branch electrode and the third branch electrode are spaced at a spacing greater than a spacing between the second limb electrode and the third limb electrode.

8. The pixel structure of claim 3, wherein each of the branch electrodes has a width less than a width of any one of the limb electrodes.

9. The pixel structure of claim 1, wherein the first stem electrode comprises a first stem body arranged transversely and a second stem body arranged longitudinally, and the second stem electrode comprises a third stem body arranged transversely and a fourth stem body arranged longitudinally.

10. A display panel, comprising a substrate and a pixel structure disposed on the substrate, and the pixel substrate comprising:
a first subpixel comprising a first stem electrode;
a second subpixel having a color different from that of the first subpixel and comprising a second stem electrode;
wherein the first subpixel is a blue subpixel, and the first stem electrode has a width greater than a width of the second stem electrode.

11. The display panel of claim 10, wherein a plurality of first domains are defined in the first subpixel by the first stem electrode, each of the first domains is provided with a first slit electrode group connected to the first stem electrode, and each of the first slit electrode groups comprises a plurality of branch electrodes arranged obliquely and spaced apart from each other;
wherein a plurality of second domains are defined in the second subpixel by the second stem electrode, each of the second domains is provided with a second slit electrode group connected to the second stem electrode, and each of the second slit electrode groups comprises a plurality of limb electrodes arranged obliquely and spaced apart from each other.

12. The display panel of claim 11, wherein all the branch electrodes in each of the first domains are arranged in parallel with each other, and all the limb electrodes in each of the second domains are arranged in parallel with each other.

13. The display panel of claim 11, wherein a sum of widths of all the branch electrodes in each of the first domains is less than a sum of widths of all the limb electrodes in each of the second domains.

14. The display panel of claim 13, wherein in each of the first domains, the greater a distance from the branch electrode to a central region of the first domain is, the smaller a width of the branch electrode is, and in each of the second domains, the greater a distance from the limb electrode to a central region of the second domain is, the smaller a width of the limb electrode is.

15. The display panel of claim 13, wherein in each of the first domains, the greater a distance from the branch electrode to a central region of the first domain is, the greater a width of the branch electrode is, and in each of the second domains, the greater a distance from the limb electrode to a central region of the second domain is, the greater a width of the limb electrode is.

16. The display panel of claim 15, wherein in each of the first domains, the first slit electrode group comprises a first branch electrode located closest to the central region of the first domain, and a second branch electrode and a third branch electrode sequentially arranged in a direction away from the first branch electrode; and
in each of the second domains, the second slit electrode group comprises a first limb electrode located closest to the central region of the second domain, and a second limb electrode and a third limb electrode sequentially arranged in a direction away from the first limb electrode;
wherein the first branch electrode has a width less than that of the first limb electrode, the second branch electrode has a width less than that of the second limb electrode, and the third branch electrode has a width less than that of the third limb electrode.

17. The display panel of claim 16, wherein the first branch electrode and the second branch electrode are spaced at a spacing greater than a spacing between the first limb electrode and the second limb electrode, and the second branch electrode and the third branch electrode are spaced at a spacing greater than a spacing between the second limb electrode and the third limb electrode.

18. The display panel of claim 13, wherein each of the branch electrodes has a width less than a width of any one of the limb electrodes.

19. The display panel of claim 10, wherein the first stem electrode comprises a first stem body arranged transversely and a second stem body arranged longitudinally, and the second stem electrode comprises a third stem body arranged transversely and a fourth stem body arranged longitudinally, wherein the first stem body has a width greater than that of the third stem body, and/or the second stem body has a width greater than that of the fourth stem body.

20. The display panel of claim 10, wherein the pixel structure further comprises a third subpixel, the second subpixel is one of a red subpixel or a green subpixel, and the third subpixel is the other one of the red subpixel or the green subpixel.
